(19) United States
(12) Patent Application Publication
(10) Pub. No.: US 2007/0021064 A1
(43) Pub. Date: Jan. 25, 2007

(54) Routing method for an ad hoc networks

(76) Inventors: Ingo Gruber, Planegg (DE); Hui Li, Beijing (CN)

Correspondence Address: STAAS & HALSEY LLP, SUITE 700, 1201 NEW YORK AVENUE, N.W., WASHINGTON, DC, 20005, US

(21) Appl. No.: 10/547,358

(22) PCT Filed: Feb. 9, 2004
(86) PCT No.: PCT/EP04/01157

§ 371 Date: Aug. 6, 2006

(30) Foreign Application Priority Data
Feb. 28, 2003 (EP) 03004531.4

(51) Int. Cl. H04B 7/00

(52) U.S. Cl. 455/41.2

(57) ABSTRACT

In a radio communication system formed of a central radio station and subscriber radio stations each having a radio transmission range, the subscriber radio stations are at least partially mobile and each radio station is disposed within the radio transmission range of at least one adjacent subscriber radio station. User data is sent from radio station to radio station within the range of a subscriber radio station in order to transfer user data. User data can be transferred directly or can be transferred via one or several other radio stations from any particular first subscriber radio station to any particular second subscriber radio station in the radio communication system. The central radio station transmits information via the adjacent subscriber radio stations of each subscriber radio station within at least one part of the radio communication system to the plurality of subscriber-sided radio stations within the at least one part of the radio communication system. As a result, signaling costs in ad hoc networks can be reduced.

### CROSS REFERENCE TO RELATED APPLICATIONS

This application is based on and hereby claims priority to European Application No 03004531 filed on Feb. 28, 2003, the contents of which are hereby incorporated by reference.

### BACKGROUND OF THE INVENTION

In radio communication systems, information (for example control signals or user information such as speech, images, short messages or other information) are transmitted between the transmitting and receiving radio stations via a radio interface, by electromagnetic waves.

In ad hoc networks (also called self-organizing networks), radio stations have the capability to establish a radio link between each other without a central switching device. In this case, the link between two radio stations is effected either directly or, for greater distances, via other radio stations which form relay stations for the link. Thus user information is transmitted from radio station to radio station over distances which correspond to the radio reach of the radio stations. The radio stations in a self-organizing network can be mobile radio stations (for example, mobile radio devices belonging to individuals or in vehicles) and/or mainly stationary radio stations (for example, computers, printers, household devices). In order to be part of an ad hoc network, a radio station must be located within the radio coverage area of at least one neighboring radio station. Examples of self-organizing networks are such wireless local area networks (WLANs) as HiperLAN or IEEE 802.11. Such networks find their application not only in the usual Internet and telecommunications areas, but also in the field of inter-vehicle communication such as, for example, in danger warning systems or cooperative vehicle assistance systems.

One special advantage of ad hoc networks lies in their great mobility and flexibility. However, these factors also represent a major challenge for routing methods. In a radio communication system which consists of several radio stations, a path must be found for a information packet from the transmitter, and possibly via several radio stations which forward the information packet, to the receiver. The process of selecting the path is referred to as routing. If the radio stations are mobile radio stations, then the topology of the network generally changes with time. A suitable routing method must take account of these continuous changes.

For this purpose there are proactive and reactive methods. In the case of a proactive routing method, at any point in time each radio station knows all the neighbors of any particular radio station. Hence a radio station can immediately establish any arbitrary link to another radio station in the ad hoc network. This method does prove disadvantageous if the speed of movement of the mobile radio stations is high, or if large volumes of information are to be communicated. When a reactive routing method is used, the current topology of the network is not known to the radio stations. When required, a radio station will flood the network with a message, by which a path is established to the radio station which is desired as the receiver. This flooding message contains the addresses of the transmitting and receiving stations.

The AODV (ad hoc on demand vector routing) and DSR (dynamic source routing) methods are familiar representatives of reactive routing algorithms. In the case of the DSR method, the packet with the user information contains all the addresses for the path between the transmitter and the receiver, while with the AODV method the individual radio stations on the path store the neighbor which is relevant in each case for the path.

The greater is the number of radio stations of which the ad hoc network is constructed, the more effort is required to determine the current topology of the network by flooding messages. The number of flooding message to be transmitted increases rapidly with the number of radio stations, so that when there are many radio stations the volume of user information which can be transported is significantly reduced because of the large volume of flooding messages.

### SUMMARY OF THE INVENTION

An object underlying the invention is to present a method, of the type mentioned in the introduction, which permits efficient routing in a network which incorporates a multitude of radio stations, at least some of which are mobile.

A radio communication system incorporates, on the subscriber side, a multitude of radio stations each with its own radio reach, and one central radio station. At least some of the radio stations on the subscriber side are mobile. Each radio station is located within the radio reach of at least one neighboring subscriber-side radio station. For the purpose of transmitting user information, this user information is transmitted from radio station to radio station over the radio reach of a subscriber-side radio station. In the radio communication system, user information can be transmitted, directly or via one or more other radio stations, from any arbitrary first subscriber-side radio station to any arbitrary second subscriber-side radio station. In accordance with the invention, the central radio station sends information, about the subscriber-side radio station or stations neighboring to any particular subscriber-side radio station within at least a subarea of the radio communication system, to the multitude of subscriber-side radio stations within at least the subarea of the radio communication system.

For the purpose of transmitting user information, this user information is thus transported from a first subscriber-side radio station to a neighboring radio station. The neighboring radio station can be the designated receiver of the user information. In this case, the user information would be transmitted directly. In general, this will not be the case, so that the neighboring radio station forwards the user information to a radio station neighboring to it. In this manner, the user information is forwarded to the designated receiver via several steps. Forwarding can also take place via the central radio station which forwards the user information, as do the subscriber-side radio stations, over the distance of the length of the radio reach of the subscriber-side radio stations. The subscriber-side radio stations need not all have an identical radio reach, but in general the radio reaches of the subscriber-side radio stations in an ad hoc network are of a similar size.

The central radio station transmits information about neighborhood relationships for subscriber-side radio stations in the radio communication network, i.e. network information. This information may equally well relate only to a subarea of the radio communication system, or to the entire system, i.e. each of the subscriber-side radio stations. This information provides clarification for the subscriber-side radio stations within the relevant subarea about all the neighborhood relationships of the subarea concerned. The radio reach of the central radio station in relation to the transmission of this information corresponds at least to the area covered by the radio communication system, or the subarea of it, as applicable. This radio reach is at least as large as the radio reach of the subscriber-side radio stations.

The central radio station does not need to be distinguished from the subscriber-side radio stations by its design. Rather, a subscriber-side radio station can also undertake the role of the central radio station, provided it has the characteristics necessary for the performance of the method in accordance with the invention. This includes in particular a radio reach which is sufficiently large for transmitting information to the subscriber-side radio stations within the sub-area. Hence, the central radio station can be distinguished from the subscriber-side radio stations by its design and/or by its function in relation to the method in accordance with the invention.

The fact that the subscriber-side radio stations are informed about the neighborhood relationships by the central radio station means that the effort expended on flooding messages, which are necessary for determining the current topology of the network, can generally be significantly reduced. A consequence of this is that the signaling effort within the radio communication system is diminished, so that more capacity is available for transporting user information.

In a development of the invention, the central radio station also transmits information about the subscriber-side radio station or stations which are neighboring to the central radio station. This can be realized in that, in the context of giving details of the neighborhood relationships of the subscriber-side radio station, the central radio station provides information about its own neighborhood relationships.

In one embodiment of the invention, the central radio station transmits the information by a multi-address message, i.e. by a broadcast.

Advantageously, the information will have been determined by the multitude of subscriber-side radio stations. However, this does not mean that each subscriber-side radio station among this multitude supplies the same contribution to the determination of the information. If the items of information concern only a subarea of the radio communication system, then the subscriber-side radio stations outside the subarea will not participate in the determination.

In a development of the invention, for the purpose of determining the information the subscriber-side radio stations within at least the subarea of the radio communication system send out signals to inquire about neighboring subscriber-side radio stations, in response to which signals each of the neighboring subscriber-side radio stations sends a reply, subject to the condition that it has not yet sent a reply to any other neighboring subscriber-side radio station. A subscriber-side radio station thus replies only to the first flooding message, by which the current topology of the network is to be determined: This serves to avoid redundancies.

Preferably, certain subscriber-side radio stations will communicate, to those neighboring subscriber-side radio stations to which they have sent a reply, information about neighboring subscriber-side radio stations to which they have not sent a reply. This procedure results in a bundling of items of neighborhood information at those subscriber-side radio stations which have received a reply to their flooding message. The subscriber-side radio stations which send these items of information are subject to a condition. One example of the nature of the condition is conditions which apply to the address of the subscriber-side radio station or to the number of neighbors.

In accordance with one embodiment of the invention, the central radio station transmits the information regularly. The items of information are thus dispatched at certain intervals of time which can, for example, lie between 0.1 seconds and 5 minutes, or can also correspond to a multiple of a clock frequency of the subscriber-side radio stations. In this case, each transmission of the information relates to the current, or almost current, topology of the network. Between the transmissions, the neighborhood relationships for the subscriber-side radio stations are re-determined.

### BRIEF DESCRIPTION OF THE DRAWINGS

These and other objects and advantages of the present invention will become more apparent and more readily appreciated from the following description of an exemplary embodiment, taken in conjunction with the accompanying drawings of which:

FIG. 1 is a schematic diagram of a radio communication system,

FIG. 2 is a schematic diagram of a section of a radio communication system,

FIG. 3 is a schematic diagram illustrating a first part of a method in accordance with the invention,

FIG. 4 is a schematic diagram illustrating a second part of a method in accordance with the invention,

FIG. 5 is a schematic diagram illustrating a third part of a method in accordance with the invention,

FIG. 6 is a schematic diagram illustrating a fourth part of a method in accordance with the invention,

FIG. 7 is a schematic diagram illustrating a tree of neighborhood relationships,

FIG. 8 is a schematic diagram illustrating the dispatch of a multi-address message by the central radio station.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

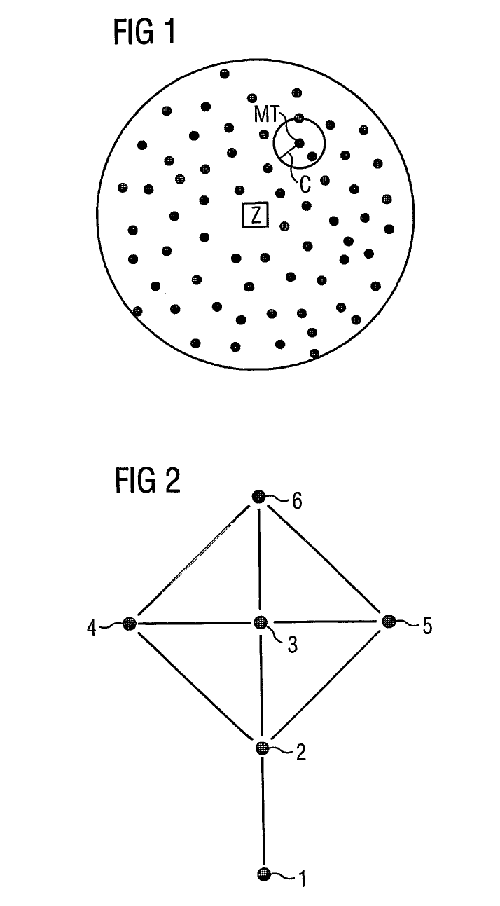

FIG. 1 shows in schematic form a radio communication system, or a network of radio stations which forms the radio communication system, as applicable. This can be, for example, an IEEE 802.11 WLAN (wireless local area network). Roughly in the centre of the network is located a central radio station Z. Furthermore, the network consists of a multitude of mobile radio stations MT. The typical radio reach C of a mobile radio station is indicated around one of the mobile radio stations MT by a circle. The exact value of the radio reach can be different from one mobile radio station to another mobile radio station. This means that it is possible for the radio communication system under consideration to include various types of radio stations, and for them to communicate with one another. Furthermore, it is also possible for many of the radio stations to be fixed-location radio stations. It can be seen that the radio station MT under consideration has two neighboring radio stations within its radio reach C. As a result of the mobility of the radio stations, the neighborhood relationships between the radio stations change with time, and hence also the topology of the network.

The radio coverage area of the central radio station Z, which corresponds roughly to the larger of the two circles in FIG. 1, is significantly larger than that of the radio stations MT. The radio stations MT are equipped with two types of radio interfaces: a first one for communication between the radio stations MT, and a second one for the receipt of information from the central radio station Z. The central radio station also has radio interfaces of this type, but the second radio interface is used for sending out information.

In what follows, a method in accordance with the invention is clarified by reference to a small section of a radio communication system, as shown in FIG. 2. This section consists of the mobile radio stations 1, 2, 3, 4, 5 and 6. The links between neighboring radio stations are indicated in FIG. 2 by lines. Radio station 1 is a neighbor to radio station 2, radio station 2 to radio stations 1, 3, 4 and 5, radio station 3 to the radio stations 2, 4, 5 and 6, radio station 4 to the radio stations 2, 3 and 6, radio station 5 to the radio stations 2, 3 and 6, and radio station 6 to the radio stations 3, 4 and 5. In total there are nine links or neighborhood relationships between the radio stations 1, 2, 3, 4, 5 and 6. These nine links, i.e. the current topology of the network, are to be determined and publicized to the radio stations 1, 2, 3, 4, 5 and 6. For this purpose, the radio stations 1, 2, 3, 4, 5 and 6 collect information about their neighbors, and transmit it in an appropriate way to the central radio station.

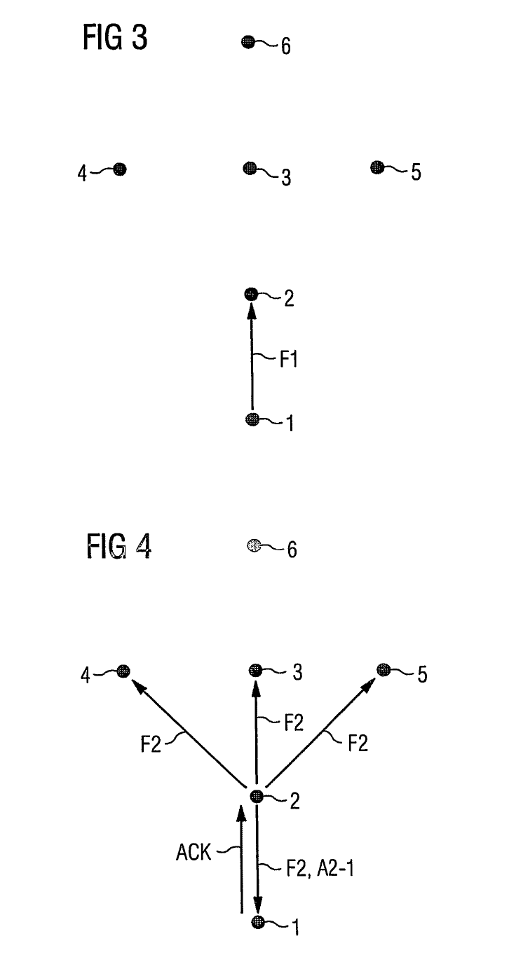

It is assumed that radio station 1 is located nearest to the central radio station. Radio station 1 initiates the method by transmitting a flooding message F1, as shown in FIG. 3. This message F1 is transmitted as a multi-address message, so that all the neighbors of radio station 1 receive the flooding message F1. The flooding message F1 contains the information that the message is one by which the neighborhood relationships in the network are to be determined, plus an identification number for the flooding message F1 and the identification address of radio station 1.

The prompt for sending out the flooding message F1 is received by radio station 1, for example, from the central radio station. It is also possible that radio station 1 transmits this flooding message F1 after expiry of the time interval, which it knows, since the last flooding message F1 which it sent.

After receiving the flooding message F1 from radio station 1, radio station 2 also transmits a flooding message F2. This transmission is shown in FIG. 4. Flooding message F2 contains the information that the message is one by which the neighborhood relationships in the network are to be determined, plus the identification number for the flooding message F2, the identification address of radio station 2 and the information that radio station 2 regards radio station 1 as its relevant neighboring radio station on the path to the central radio station. The latter information is only of interest for radio station 1, and not for the other stations neighboring radio station 2. The information items about the neighborhood relationships are transmitted to the central radio station via the relevant neighboring radio station on the path to the central radio station. The information about the relevant neighboring radio station on the path to the central radio station indicates that for the radio station 1 the flooding message F2 from radio station 2 is a reply A2-1 to its own flooding message F1. From the reply A2-1 from radio station 2, radio station 1 can deduce that radio station 2 is its neighboring radio station and, furthermore, that it will receive from radio station 2 items of information which are to be forwarded to the central radio station.

In order to increase the reliability of the method, it is possible for the radio station 1 to transmit to radio station 2 a confirmation message ACK for the reply A2-1 from radio station 2. This confirmation message ACK can inform the radio station 2 that, for example, radio station 1 will wait for an unlimited time, or for a certain interval of time, to receive from radio station 2 information about the topology of the network. After the time interval has elapsed, radio station 1 can then report to the central station that it has received no information from radio station 2 about the neighborhood relationships within the network.

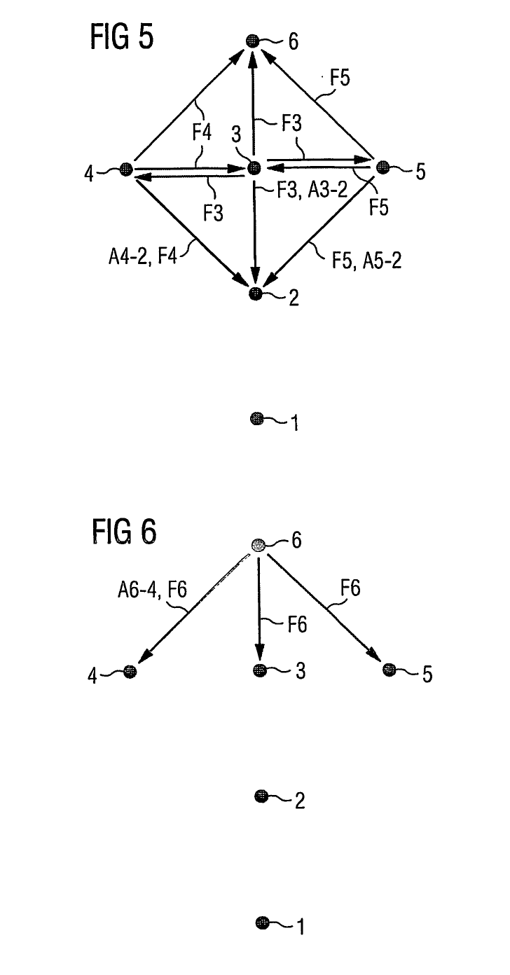

Radio stations 3, 4 and 5 receive the flooding message from radio station 2, whereupon they transmit their own flooding messages F3, F4 and F5. This transmission is shown in FIG. 5. The flooding messages F3, F4 and F5 contain the information that the message is one by which the neighborhood relationships in the network are to be determined, plus the identification number for the flooding message F3, F4 or F5, the identification address of the relevant radio station 3, 4 or 5 and the information that the radio station concerned, 3, 4 or 5 regards radio station 2 as its relevant neighboring radio station on the path to the central radio station. Radio station 2 regards these three flooding messages as replies A3-2, A4-2 and A5-2 to its flooding message F2. It now knows that it has, apart from radio station 1, three further neighbors. As the three radio stations 3, 4 and 5 have indicated to radio station 2 that they regard the latter as the neighboring radio station for the return path to the central radio station, radio station 2 makes the assumption that it will receive three messages with information about the neighborhood relationships, which it will forward to radio station 1.

Furthermore, radio station 3 receives the flooding message F4 from radio station 4, and vice versa. Similarly, radio station 5 receives the flooding message F3 from radio station 3 and vice versa. However, at the point in time when they receive the flooding messages concerned, F3, F4 or F5 from their neighboring radio station 3, 4 or 5, radio stations 3, 4 and 5 have transmitted a flooding message of their own, F3, F4 or F5, and because of this they do not reply on receipt of the flooding messages F3, F4 or F5 from the neighboring station concerned. Radio station 4 now knows that in addition to radio station 2, in response to whose flooding message F2 it transmitted its flooding message F4, and which it regards as a radio station on the return path to the central radio station, it also has as a further neighbor radio station F3. In an analogous manner, radio station 3 knows of the existence of radio stations 4 and 5 in its neighborhood, and radio station 5 of the existence of radio station 3 in its neighborhood.

Radio station 6 receives the three flooding messages F3, F4 and F5. In the example under consideration, it is assumed that flooding message F4 from radio station 4 is the first to reach radio station 6. At that point, radio station 6 transmits a flooding message F6 of its own, as shown in FIG. 6. Flooding message F6 contains the information that the message is one by which the neighborhood relationships in the network are to be determined, plus the identification number for the flooding message F6, the identification address of radio station 6 and the information that radio station 6 regards radio station 4 as its relevant neighboring radio station on the path to the central radio station. Radio station 4 regards this flooding message as a reply A6-4 to its flooding message F4. It now knows that, apart from radio station 2 and radio station 3, the radio station F6 is also resident in its neighborhood. Radio stations 3 and 5 also learn of the existence of radio station 6 in their neighborhood from the flooding message F6.

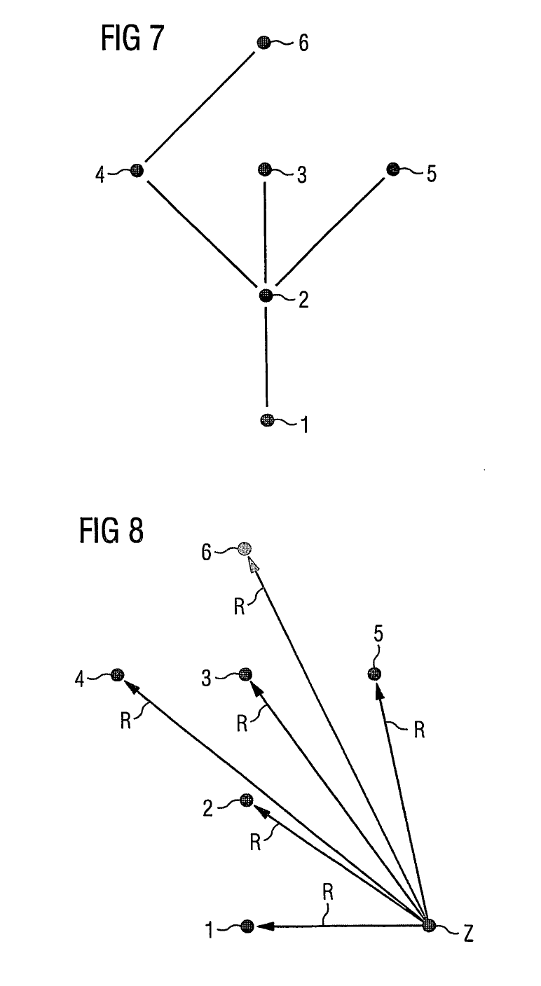

Each of the radio stations which has received a reply to its flooding message transmits the address of the appropriate radio station, which it regards as the relevant radio station for the return path to the central radio station, in each case to that radio station which it uses as the return path to the central radio station. Thus, radio station 4 sends the address of radio station 6 to radio station 2, and radio station 2 sends the addresses of radio stations 3, 4 and 5 to radio station 1. In addition, radio station 1 must forward the address of radio station 6 communicated to it by radio station 4, or the neighborhood relationship between radio stations 4 and 6, as applicable, to radio station 1. The tree of neighborhood relationships created in this way is shown in FIG. 7.

In order to complete the information about the neighborhood relationships between radio stations 1, 2, 3, 4, 5 and 6, it is still necessary to add in the neighborhood relationships between radio stations 3 and 4, between radio stations 3 and 5, plus those between radio stations 3 and 6, and between 5 and 6. In the case of the neighborhood relationship between radio stations 3 and 6, for example, it is possible both for radio station 3 to transmit, via radio station 2 to radio station 1, the existence of radio station 6 which is neighboring to it, and also for radio station 6 to transmit, via radio stations 4 and 2 to radio station 1, the existence of radio station 3 which is neighboring to it. If both radio stations 3 and 6 transmit this information, then radio station 2 receives redundant information about the neighborhood relationships. In this case, the redundancy can be removed from the information by either radio station 2 or radio station 1, or even by the central radio station.

It is of advantage if radio stations 3 and 6 do not both send off the information about their neighboring radio station concerned, 6 or 3. The radio station which should transmit the information can be determined by a particular condition. In the example under consideration it is assumed that the radio station with the larger address transmits the information. Accordingly, radio station 6 transmits to radio station 4 the information about the existence of radio station 3 in its neighborhood. In the same way, radio station 6 transmits information to radio station 4 about radio station 5, radio station 5 transmits information to radio station 2 about radio station 3, and radio station 4 transmits information to radio station 2 about radio station 3.

The sending of the various items of information about the neighboring radio stations is here effected in a single message. Thus, radio station 4 sends to radio station 2 a message in which it indicates radio stations 6 and 3 as its neighbors, and that radio stations 6 and 3 are neighbors, as are radio stations 6 and 5. The information which a radio station itself determines and that which is sent to it by another radio station about neighborhood relationships can then be sent off in a common message.

Radio station 1 transmits to the central radio station the information it has received about the neighborhood relationships. As shown in FIG. 8, the central radio station Z thereupon -transmits all the information about the neighborhood relationships between the radio stations 1, 2, 3, 4, 5 and 6 by a multi-address message R to radio stations 1, 2, 3, 4, 5 and 6. The format used by the central radio station Z for sending out the multi-address message R can differ from the format of the message sent by radio station 1. Thus it is possible for the central radio station Z to represent the information in a particularly efficient way before sending it out.

After they receive the multi-address message R, the current topology of the network is known to the radio stations 1, 2, 3, 4, 5 and 6, so that the routing of a information packet from a transmitting radio station to a receiver can now be efficiently performed. Because the radio stations 1, 2, 3, 4, 5 and 6 are mobile radio stations, the topology of the network changes in the course time. For this reason, the method for determining the neighborhood relationships by the radio stations 1, 2, 3, 4, 5 and 6 and for sending out the multi-address message by the central radio station Z is performed at regular intervals. The time interval between repetitions of the method can be adjusted, for example, for the average speed of movement of the radio stations 1, 2, 3, 4, 5 and 6. A multiple of the clock frequency of radio stations 1, 2, 3, 4, 5 and 6 turns out to be suitable for the time interval. The identification numbers of the flooding messages F1, F2, F3, F4, F5 and F6 agree with each other for precisely one determination of the current topology of the network. After the time interval has expired, the next determination of the neighborhood relationships is initiated, and for this another identification number is used for the flooding messages. Hence, from the identification number of the flooding messages it is possible to deduce the determination procedure to which the flooding message concerned is assigned.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. transmitting user information from any arbitrary first subscriber-side radio station to any arbitrary second subscriber-side radio station, either directly or via at least one other radio station; and
transmitting information from the central radio station about every neighboring subscriber-side radio station of each subscriber-side radio station within at least a subarea of the radio communication system to every subscriber-side radio station of at least the subarea.

12. A method in accordance with claim 11, further comprising transmitting from the central radio station information about the neighboring subscriber-side radio stations of the central radio station.

13. A method in accordance with claim 11, wherein the central radio station transmits the information by a multi-address message.

14. A method in accordance with claim 11, wherein the information is determined by the subscriber-side radio stations.

15. A method in accordance with claim 14, further comprising:
transmitting, from the subscriber-side radio stations within at least the subarea of the radio communication system, signals inquiring about neighboring subscriber-side radio stations;
transmitting replies to the signals from the neighboring subscriber-side radio stations if a reply has not been transmitted to any other neighboring subscriber-side radio station; and
determining the information from the signals and replies.

16. A method in accordance with claim 15, further comprising communicating from a second group of the subscriber-side radio stations to a third group of subscriber-side radio stations to which the second group have transmitted a reply, information about a fourth group of subscriber-side radio stations to which the second group has transmitted no reply.

17. A method in accordance with claim 11, wherein the central radio station transmits the information regularly.

18. A method in accordance with claim 17, wherein the central radio station transmits the information at a fixed interval of between 0.1 seconds and 5 minutes.

19. A method in accordance with claim 18, wherein the central radio station transmits the information at a fixed interval of between 0.5 seconds and one minute.

20. A method in accordance with claim 17, wherein the central radio station transmits the information at a fixed interval corresponding to a multiple of a clock frequency of the subscriber-side radio stations.
